(19) United States
(12) Patent Application Publication
(10) Pub. No.: US 2026/0148437 A1
(43) Pub. Date: May 28, 2026

(54) EFFECT PROCESSING METHOD, ELECTRONIC DEVICE, AND STORAGE MEDIUM

(71) Applicant: Beijing Zitiao Network Technology Co., Ltd., Beijing (CN)

(72) Inventors: Qi YUAN, Beijing (CN); Yi GUO, Beijing (CN); Huaiye SHEN, Beijing (CN); Boyang XIE, Beijing (CN)

(21) Appl. No.: 19/402,616

(22) Filed: Nov. 26, 2025

(30) Foreign Application Priority Data
Nov. 27, 2024 (CN) 202411721970.0

(51) Int. Cl. G06T 11/00

(52) U.S. Cl. CPC G06T 11/00

(57) ABSTRACT

The present disclosure provides an effect processing method, a device, and a medium. The method includes: acquiring a first image and a plurality of first files corresponding to a first effect, in response to an effect trigger operation for the first effect, a first file is configured to describe a scenario identification condition corresponding to a preset effect scenario; determining a candidate effect scenario from among a plurality of preset effect scenarios according to the first image and the plurality of first files, and determining a first effect scenario corresponding to the first image according to the candidate effect scenario; and generating an effect processing request according to the first effect scenario, performing a requested effect processing on the first image according to the effect processing request to obtain an effect outcome image, and displaying the effect outcome image.

### CROSS-REFERENCE TO RELATED APPLICATION

This application claims the priority to and benefits of the Chinese Patent Application, No. 202411721970.0, which was filed on Nov. 27, 2024. The aforementioned patent application is hereby incorporated by reference in its entirety.

### TECHNICAL FIELD

Embodiments of the present disclosure relate to a field of computer processing technology, and more particularly, to an effect processing method and apparatus, a device, a medium and a product.

### BACKGROUND

With the development of computer vision technology, in image processing scenarios, an increasing number of users are using effects to enrich display outcome of images. After determining an effect to be used, effect processing is performed on an image to be processed through a preset effect processing file corresponding to the effect, so as to render an effect in the image.

In the related technologies, each effect usually has one-to-one correspondence with an effect processing file. That is, after determining an effect to be used, effect processing is performed on an image through a fixed effect logic code in the effect processing file corresponding to the effect, that is, effect process operations and effect processing parameters adopted for different images to be processed are usually fixed. Since an exhibition effect of an image is closely related to content thereof, and the effect processing parameters in the effect processing file remain relatively fixed, it frequently results in situations where rendered effect outcome of images does not meet expectations when performing effect processing on the images with different contents.

### SUMMARY

Embodiments of the present disclosure provide an effect processing method and apparatus, a device, a medium and a product, so as to improve the effect processing outcome.

An embodiment of the present disclosure provides an effect processing method. The method includes:
acquiring an image to be processed (e.g., a first image) and a plurality of first files corresponding to a target effect (e.g., a first effect), in response to an effect trigger operation for the target effect, wherein a first file of the plurality of first files is configured to describe a scenario identification condition corresponding to a preset effect scenario;
determining a candidate effect scenario from among a plurality of preset effect scenarios according to the image to be processed and the plurality of first files, and determining a target effect scenario (e.g., a first effect scenario) corresponding to the image to be processed according to the candidate effect scenario; and
generating an effect processing request according to the target effect scenario, performing a requested effect processing on the image to be processed according to the effect processing request to obtain an effect outcome image, and displaying the effect outcome image.

An embodiment of the present disclosure provides an effect processing apparatus. The apparatus includes:
an effect triggering module 610, configured to acquire an image to be processed and a plurality of first files corresponding to the target effect, in response to an effect trigger operation for the target effect, wherein a first file of the plurality of first files is configured to describe a scenario identification condition corresponding to a preset effect scenario;
a scenario determining module 620, configured to determine a candidate effect scenario from among a plurality of preset effect scenarios according to the image to be processed and the plurality of first files, and determine a target effect scenario corresponding to the image to be processed according to the candidate effect scenario; and
an effect display module 630, configured to generate an effect processing request according to the target effect scenario, perform effect processing on the image to be processed according to the effect processing request to obtain an effect outcome image, and display the effect outcome image.

An embodiment of the present disclosure provides an electronic device, which includes:
at least one processor;
a storage apparatus, configured to store at least one program;
wherein the at least one program, when executed by the at least one processor, cause the at least one processor to implement the effect processing method according to any of the above embodiments.

An embodiment of the present disclosure provides a non-transitory computer-readable storage medium, which includes computer-executable instructions, wherein the computer-executable instructions, when executed by a computer processor, perform the effect processing method according to any of the above embodiments.

An embodiment of the present disclosure provides a computer program product, including a computer program, wherein the computer program, when executed by a computer processor, performs the effect processing method according to any of the above embodiments.

### BRIEF DESCRIPTION OF DRAWINGS

The above-described and other features, advantages and aspects of the respective embodiments of the present disclosure will become more apparent when taken in conjunction with the accompanying drawings and with reference to the detailed description below. Throughout the drawings, same or similar reference signs refer to same or similar elements. It should be understood that, the drawings are schematic and that originals and elements are not necessarily drawn to scale.

FIG. 1 is a schematic flow chart of an effect processing method provided by an embodiment of the present disclosure;

FIG. 2 is a schematic flow chart of another effect processing method provided by an embodiment of the present disclosure;

FIG. 3 is a schematic flow chart of yet another effect processing method provided by an embodiment of the present disclosure;

FIG. 4 is a schematic flow chart of still another effect processing method provided by an embodiment of the present disclosure;

FIG. 5 is a schematic flow chart of an optional embodiment of an effect processing method provided by an embodiment of the present disclosure;

FIG. 6 is a structural schematic diagram of an effect processing apparatus provided by an embodiment of the present disclosure; and

FIG. 7 is a structural schematic diagram of an electronic device for implementing the embodiments of the present disclosure provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units. Modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

It may be understood that before using the technical solutions disclosed in the embodiments of the present disclosure, the types, scope of use, and usage scenarios of personal information involved in the present disclosure and the like shall be informed to the user and the user's authorization shall be obtained in an appropriate manner in accordance with relevant laws and regulations.

For example, when receiving an active request from a user, a prompt message is sent to the user to explicitly prompt the user that an operation requested by the user will need to obtain and use the user's personal information. In this way, the user can choose whether to provide personal information to a software or hardware such as an electronic device, an application, a server, or a storage medium that performs the operation of the technical solution of the present disclosure according to the prompt message.

As an optional but non-limiting implementation, in response to receiving an active request from a user, the prompt message may be sent to the user in the form of a pop-up window, and the prompt message may be presented in the pop-up window in the form of text. In addition, the pop-up window may also carry a selection control for the user to select “agree” or “disagree” to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

It may also be understood that the data (including but not limited to the data itself, data acquisition, or use) involved in the technical solutions of the present disclosure shall comply with the requirements of the corresponding laws, regulations, and related provisions.

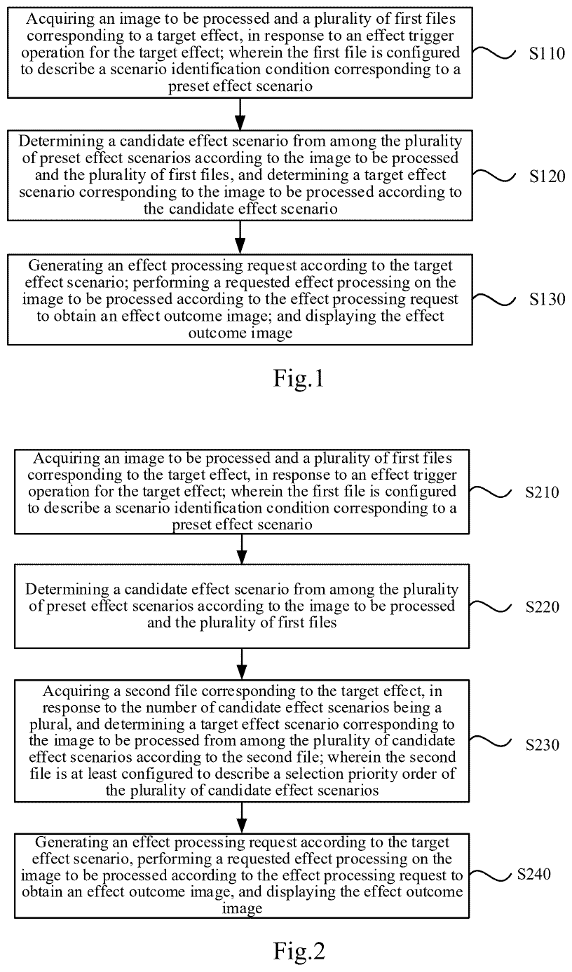

FIG. 1 is a schematic flow chart of an effect processing method provided by an embodiment of the present disclosure; the embodiment of the present disclosure is applicable to scenarios of performing effect processing on an image to be processed; the method may be executed by an effect processing apparatus; the apparatus may be implemented through software and/or hardware; optionally, the apparatus may be implemented by an electronic device; and the electronic device may be a mobile terminal, a PC, a server, or the like.

As shown in FIG. 1, the method according to this embodiment may specifically include:

S110: acquiring an image to be processed and a plurality of first files corresponding to a target effect, in response to an effect trigger operation for the target effect; wherein the first file is configured to describe a scenario identification condition corresponding to a preset effect scenario.

Specifically, the target effect may be understood as an effect that is to be applied to the image to be processed. In the embodiment of the present disclosure, the target effect may be set for the image to be processed according to actual needs, and will not be specifically limited here. Exemplarily, the target effect may include, but is not limited to, at least one selected from the group of a partial stretching effect, a style transformation effect, an image generation effect, a text generation effect, and a scenario fusion effect, etc. The image to be processed may be understood as an image requiring effect processing. Image content of the image to be processed may include, but is not limited to, at least one selected from the group of plants, persons, buildings, and animals.

In the embodiment of the present disclosure, there are a variety of methods of acquiring the image to be processed. For example, the method may be: acquiring an uploaded image as the image to be processed in response to an image upload operation; or may be acquiring a captured image as the image to be processed in response to an image capture operation; or may be acquiring a video frame as the image to be processed in response to a video frame acquire operation for a target video, wherein the video frame acquire operation may be understood as an operation for selecting and saving a picture of a specific moment from the target video.

In the embodiment of the present disclosure, the effect trigger operation may be understood as an operation for triggering effect processing on the image to be processed with effect processing logic corresponding to the target effect. In the embodiment of the present disclosure, before responding to the effect trigger operation for the target effect, the method may further include: receiving the effect trigger operation for the target effect. In the embodiment of the present disclosure, there are a variety of triggering methods of the effect trigger operation for the target effect. Exemplarily, the effect trigger operation for the target effect may be: a control trigger operation (e.g., a click operation or a swipe operation, etc.) applied to an effect triggering control for triggering the target effect; or sound information collected by an audio collecting apparatus for enabling the target effect; or motion information collected by a motion collecting apparatus for enabling the target effect; etc. Wherein the effect triggering control may be a control element set on an application interface.

As described above, the first file may be configured to describe the scenario identification condition corresponding to the preset effect scenario. Wherein, the preset effect scenario may be understood as an effect scenario preset for performing effect processing on the image to be processed. The preset effect scenario may be determined according to the image content of the image to be processed. Specifically, the preset effect scenario may be determined according to a target object included in the image to be processed and object-association information corresponding to the target object. Wherein the object-association information corresponding to the target object may include at least one selected from the group of information: category corresponding to the target object, the number of the target objects, size of the target object, position of the target object, or the like.

In the embodiment of the present disclosure, both classification modes and identification conditions of the preset effect scenario may be set according to actual needs, and will not be specifically limited here. Exemplarily, the preset effect scenario may include a single-object effect scenario and a multi-object effect scenario; and the multi-object effect scenario may further include a single-category object scenario and a multi-category object scenario. The preset effect scenario may further include a single-category object scenario and a multi-category object scenario; and further, each of the single-category object scenario and the multi-category object scenario may further include at least one selected from the group of a singular-number scenario and a plural-number scenario. Wherein, the scenario identification condition may be understood as an identification condition used for identifying whether the image to be processed satisfies the preset effect scenario.

Wherein the first file corresponds to the preset effect scenario; and the first file may be configured to describe at least one scenario identification condition corresponding to the preset effect scenario. That is to say, the first file may have one-to-one correspondence with the preset effect scenario, that is, different first files correspond to different preset effect scenarios. With respect to a certain preset effect scenario, the first file may include one or more scenario identification conditions for describing the preset effect scenario, to identify whether the image to be processed satisfies the preset effect scenario through one scenario identification condition or a combination of a plurality of scenario identification conditions. It should be noted that in the embodiment of the present disclosure, an advantage of defining corresponding first files for different preset effect scenarios is that the effect processing logic of the preset effect scenarios may be reused quickly and conveniently, without performing code migration on an effect processing logic code, which reduces development costs.

In the embodiment of the present disclosure, the first file may represent and describe the scenario identification condition corresponding to the preset effect scenario by using a key-value pair manner, making the scenario identification conditions more intuitive and comprehensible, thereby enhancing readability of the first file. In an optional implementation, a file format of the first file may be JavaScript Object Notation (JSON) format. Further, in the JSON-formatted first file, the key-value pair is adopted to represent and describe the scenario identification condition corresponding to the preset effect scenario. The JSON-formatted first file facilitates parsing, has strong portability, is easily extensible, and may support complex data structures.

In the embodiment of the present disclosure, before or after the acquiring the plurality of first files corresponding to the target effect, the method may further include: receiving a condition edit operation for at least one scenario identification condition in the first file, and updating the first file according to the condition edit operation. By adopting the technical solution, flexible editing for the scenario identification condition of the preset effect scenario may be implemented through a simple interactive operation, so that the first file is edited quickly and conveniently, to further adjust an effect processing outcome and enhance effect processing experience.

Wherein the condition edit operation may be understood as an operation for editing the scenario identification condition in the first file. Optionally, the condition edit operation may include at least one selected from the group of a condition add operation, a condition modify operation, a condition delete operation, and other operations. Wherein the condition add operation may be understood as an operation configured to add a scenario identification condition to the first file. The condition modify operation may be understood as an operation configured to modify a scenario identification condition in the first file. The condition delete operation may be understood as an operation configured to delete a scenario identification condition in the first file. Exemplarily, the first file may be exhibited on a preset interface; wherein the preset interface may be understood as an interface configured to display the first file; and the first file may include one or more scenario identification conditions. After receiving a condition edit operation for the one or more scenario identification conditions, edited scenario identification conditions may be obtained. Further the first file may be updated based on the edited scenario identification conditions.

S120: determining a candidate effect scenario from among the plurality of preset effect scenarios according to the image to be processed and the plurality of first files, and determining a target effect scenario corresponding to the image to be processed according to the candidate effect scenario.

Herein, the candidate effect scenario may be understood as an effect scenario determined from among the plurality of preset effect scenarios according to the image to be processed and the plurality of first files. The number of candidate effect scenarios may be one or a plural. The target effect scenario may be understood as an effect scenario determined from the candidate effect scenarios that corresponds to the image to be processed, and may be configured to generate an effect processing request for performing effect processing on the image to be processed. Wherein the effect processing request may be configured to perform effect processing on the image to be processed, to obtain an effect outcome image. In the embodiment of the present disclosure, the effect processing request may include an image identifier of the image to be processed, a scenario identifier of the target effect scenario, and an effect processing parameter of the target effect scenario. It may be understood that the image identifier may be configured to distinguish different images. Optionally, the image identifier may include an image storage path, for example, an absolute storage path or a relative storage path. The scenario identifier may be configured to distinguish different effect scenarios.

In the embodiment of the present disclosure, the determining a candidate effect scenario from among the plurality of preset effect scenarios according to the image to be processed and the plurality of first files, may include: determining the preset effect scenario corresponding to the first file as the candidate effect scenario in response to the image to be processed satisfying the scenario identification condition included in the first file. By adopting the technical solution, scenario determination may be performed on the image to be processed rapidly and effectively, and the preset effect scenario that closely matches the image to be processed may be determined, thereby implementing scenario-specific processing on the image to be processed.

Specifically, for each first file, the image content of the image to be processed is matched with some or all of the scenario identification conditions of the first file, so that it may be determined whether the image to be processed satisfies some or all of the scenario identification conditions included in the first file.

As an optional implementation of the embodiment of the present disclosure, in response to the image to be processed satisfying all the scenario identification conditions included in the first file, the preset effect scenario corresponding to the first file is determined as the candidate effect scenario. By adopting the technical solution, a high degree of matching between the image to be processed and the preset effect scenario may be ensured, thereby fully guaranteeing the effect processing outcome.

Considering that in practical applications, image content is diversified and the preset effect scenario may not cover all possible scenarios, as another optional implementation of the embodiment of the present disclosure, in response to the image to be processed satisfying some (including all) of the scenario identification conditions included in the first file, the preset effect scenario corresponding to the first file is determined as the candidate effect scenario. By adopting the technical solution, a preset effect scenario that potentially matches with the image to be processed may be determined, which is particularly suitable for a situation where there is no preset effect scenario completely matching with the image to be processed, thereby ensuring successful processing of the image to be processed while generating the appropriate effect processing request that closely matches with the image to be processed to the greatest extent possible.

In the embodiment of the present disclosure, there are a variety of methods of determining the target effect scenario corresponding to the image to be processed according to the candidate effect scenario. As an optional implementation of the embodiment of the present disclosure, in response to the number of candidate effect scenarios being one, the determining the target effect scenario corresponding to the image to be processed according to the candidate effect scenario may specifically include: determining the candidate effect scenario as the target effect scenario corresponding to the image to be processed.

As another optional implementation of the embodiment of the present disclosure, in response to the number of candidate effect scenarios being a plural, the determining the target effect scenario corresponding to the image to be processed according to the candidate effect scenarios may include at least one selected from the group of operations: randomly selecting one candidate effect scenario as the target effect scenario; determining the target effect scenario from among the plurality of candidate effect scenarios according to priorities in response to the priorities being set for the plurality of candidate effect scenarios; determining the number of scenario identification conditions satisfied by the image to be processed in the first file for each first file, and determining the target effect scenario from among the plurality of candidate effect scenarios according to the numbers of satisfied conditions corresponding to the plurality of first files; etc. Further, the determining the target effect scenario from among the plurality of candidate effect scenarios according to the numbers of satisfied conditions may include: determining a candidate effect scenario corresponding to the maximum number of satisfied conditions as the target effect scenario; or, respectively determining the total number of scenario identification conditions in each first file and determining a condition-number ratio of the number of satisfied conditions to the total number of conditions corresponding to each first file; and determining the target effect scenario from among the plurality of candidate effect scenarios according to the condition-number ratio corresponding to the plurality of first files.

S130: generating an effect processing request according to the target effect scenario; performing a requested effect processing on the image to be processed according to the effect processing request to obtain an effect outcome image; and displaying the effect outcome image.

Wherein the effect outcome image may be understood as an image obtained after performing effect processing on the image to be processed. Specifically, after determining the target effect scenario, the effect processing request may be generated according to the target effect scenario. Subsequently, the effect processing file corresponding to the target effect scenario may be determined according to the effect processing request. Then, effect processing may be performed on the image to be processed according to the effect processing file. In the embodiment of the present disclosure, the effect processing request may further carry an effect processing parameter. In such case, the performing effect processing on the image to be processed according to the effect processing file may specifically be: performing the requested effect processing on the image to be processed according to the effect processing parameter carried in the effect processing request and the effect processing file, thereby obtaining the effect outcome image corresponding to the image to be processed. After obtaining the effect outcome image, the effect outcome image may be displayed.

In the embodiment of the present disclosure, the performing a requested effect processing on the image to be processed according to the effect processing parameter in the effect processing request and the effect processing file may include: updating the effect processing file according to the effect processing parameter in the effect processing request, and performing effect processing on the image to be processed according to the updated effect processing file. Specifically, the updating the effect processing file according to the effect processing parameter in the effect processing request may include, but is not limited to, at least one selected from the group of operations: adding an effect processing parameter in the effect processing request to the effect processing file to modify a default effect processing parameter in the effect processing file; replacing an effect processing parameter in the effect processing request with an effect processing parameter in the effect processing file; adjusting the effect processing parameter in the effect processing request according to the effect processing parameter in the effect processing file, etc. The effect processing file may include at least one editable effect processing parameter. It should be noted that the effect processing parameter in the effect processing request may be one or more (some or all) of the editable effect processing parameters in the effect processing file.

In the embodiment of the present disclosure, before the performing effect processing on the image to be processed according to the effect processing file, the method further includes: creating an effect processing file corresponding to the preset effect scenario. As an optional implementation of the embodiment of the present disclosure, a graphical programming tool is adopted to pre-construct a corresponding graphically programmed effect processing file for the preset effect scenario. Based on this, the effect processing file corresponding to the target effect scenario may be matched from the plurality of pre-created effect processing files, that is, the graphically programmed effect processing file corresponding to the target effect scenario is obtained. In the embodiment of the present disclosure, an editable effect processing parameter is set in the graphically programmed effect processing file corresponding to the target effect scenario, so as to facilitate adjustment of the effect outcome corresponding to the target effect scenario by adjusting the effect processing parameter.

It should be noted that there are a variety of methods of performing effect processing on the image to be processed in the effect processing file, for example, one or more image processing algorithms and/or effect processing models, etc. may be adopted. In the embodiment of the present disclosure, in response to the effect processing file including an effect processing model, the editable effect processing parameter in the effect processing file may include a model-associated parameter of the effect processing model corresponding to the target effect. In the embodiment of the present disclosure, the model-associated parameter may at least include a model input parameter. In addition, the model-associated parameter may further include a model training parameter (e.g., the number of times of model training) and a model structural parameter. In the embodiment of the present disclosure, the model input parameter may include a preset parameter and/or a custom-set parameter. The model input parameter may at least include model prompt information. Optionally, the effect processing model may be a content generation model. The model prompt information may include information used for prompting the generated effect processing outcome. Optionally, the model prompt information may include positive prompt information and/or negative prompt information. Wherein the positive prompt information may be understood as information configured to describe what is expected to be presented in the effect outcome image. The negative prompt information may be understood as information configured to describe what should be avoided in the effect outcome image, for example, content to be avoided in the effect outcome image, description of quality problems that should not appear in the effect outcome image, and an operation that should not be performed on the image to be processed, etc.

On the basis of the above-described embodiment, before the performing a requested effect processing on the image to be processed according to the effect processing request, effect preprocessing may also be performed on the image to be processed. In the embodiment of the present disclosure, there are a variety of methods of effect preprocessing, which will not be specifically limited here, for example, filter addition or beauty processing, etc. On the basis of the above-described embodiment, in the embodiment of the present disclosure, after obtaining the effect outcome image, the method may further include: correspondingly storing the image to be processed and the effect outcome image corresponding to the image to be processed to the local or cloud.

In the embodiment of the present disclosure, the displaying the effect outcome image may specifically include: displaying the effect outcome image with a preset image display parameter; wherein the preset image display parameter may include, but is not limited to, at least one selected from the group of: preset display size, preset display position, preset display duration, etc. Wherein the preset display size may be calculated based on a display size and a preset proportion of the image to be processed. The preset proportion may be set according to actual needs, and a value thereof will not be specifically limited here, which may be, for example, 0.5, 1 or 1.6, etc.

In the technical solution of the embodiment of the present disclosure, the image to be processed and the plurality of first files corresponding to the target effect are acquired in response to the effect trigger operation for the target effect. Since the first file is configured to describe the scenario identification condition corresponding to the preset effect scenario, division of the target effect according to a plurality of effect scenarios may be implemented through the plurality of first files corresponding to the plurality of preset effect scenarios, which supports effect processing for divided effect scenarios with respect to the same effect. Moreover, by presenting the scenario identification condition corresponding to the preset effect scenario in the form of static data file, the scenario identification condition corresponding to the plurality of preset effect scenarios may be conveniently modified, maintained and reused. Thereafter, by determining the candidate effect scenario from among the plurality of preset effect scenarios according to the image to be processed and the plurality of first files, and then determining the target effect scenario corresponding to the image to be processed according to the candidate effect scenario, the effect processing scenario applicable to the image to be processed may be identified more rapidly according to the plurality of first files, thereby implementing targeted processing of the image to be processed. Further, by generating the effect processing request according to the target effect scenario, performing the requested effect processing on the image to be processed according to the effect processing request to obtain the effect outcome image, and displaying the effect outcome image, the effect processing scenario applicable to the image to be processed may be adopted to perform effect processing on the image to be processed, so that different images to be processed may exhibit effects that closely match with the images to be processed. The technical solution of the embodiment of the present disclosure solves the technical problem in the related technologies that the effect outcome of the image fails to meet expectations since the effect process operation and the effect processing parameter in the effect processing file are relatively fixed, implements decoupling the effect processing logic code through the first file, and achieves the technical effect of reusing the effect processing logic.

FIG. 2 is a schematic flow chart of another effect processing method provided by an embodiment of the present disclosure. Based on the above-described embodiment, the technical solution of this embodiment provides further refinement regarding the method of determining the target effect scenario corresponding to the image to be processed according to the candidate effect scenario. Optionally, the method of determining the target effect scenario corresponding to the image to be processed according to the candidate effect scenario includes: acquiring a second file corresponding to the target effect, in response to the number of candidate effect scenarios being a plural, and determining the target effect scenario corresponding to the image to be processed from among the plurality of candidate effect scenarios according to the second file; wherein the second file is at least configured to describe a selection priority order of the plurality of candidate effect scenarios. For specific implementation, description of this embodiment may be referred to. Technical features that are identical or similar to those in the foregoing embodiments will not be repeated here. As shown in FIG. 2, the method according to this embodiment may specifically include:
S210: acquiring an image to be processed and a plurality of first files corresponding to the target effect, in response to an effect trigger operation for the target effect; wherein the first file is configured to describe a scenario identification condition corresponding to a preset effect scenario.

S220: determining a candidate effect scenario from among the plurality of preset effect scenarios according to the image to be processed and the plurality of first files.

S230: acquiring a second file corresponding to the target effect, in response to the number of candidate effect scenarios being a plural, and determining a target effect scenario corresponding to the image to be processed from among the plurality of candidate effect scenarios according to the second file; wherein the second file is at least configured to describe a selection priority order of the plurality of candidate effect scenarios.

Wherein the second file may be at least configured to describe the selection priority order of the plurality of candidate effect scenarios. In the embodiment of the present disclosure, the second file may be configured to describe the selection priority order of the plurality of preset effect scenarios, wherein the plurality of preset effect scenarios may include the plurality of candidate effect scenarios corresponding to the image to be processed. In brief, the selection priority order of the effect scenarios described in the second file may include not only the plurality of candidate effect scenarios corresponding to the image to be processed, but also preset effect scenarios other than the plurality of candidate effect scenarios corresponding to the image to be processed. In the embodiment of the present disclosure, a file format of the second file may be JSON format. In the second file, a candidate effect scenario and a selection priority order corresponding to the candidate effect scenario are identified in a form of key-value pair. An advantage of such setting is that not only the target effect scenario may be determined from among the candidate effect scenarios, but also the selection priority order of the candidate effect scenarios may be flexibly modified.

Specifically, in response to the number of candidate effect scenarios being a plural, the second file configured to describe the selection priority order of the plurality of candidate effect scenarios may be acquired. After acquiring the second file, the candidate effect scenario corresponding to the image to be processed, namely, the target effect scenario, may be determined based on the selection priority order of the plurality of candidate effect scenarios in the second file.

Exemplarily, the candidate effect scenarios corresponding to the image to be processed in the second file include: a first candidate effect scenario, a second candidate effect scenario and a third candidate effect scenario. Wherein the selection priority order of the first candidate effect scenario, the second candidate effect scenario and the third candidate effect scenario may be sequentially: the first candidate effect scenario, the second candidate effect scenario and the third candidate effect scenario; or, the second candidate effect scenario, the first candidate effect scenario and the third candidate effect scenario. Accordingly, in response to the selection priority order of the first candidate effect scenario, the second candidate effect scenario and the third candidate effect scenario being sequentially the first candidate effect scenario, the second candidate effect scenario and the third candidate effect scenario, the first candidate effect scenario may be determined as the target effect scenario. Similarly, in response to the selection priority order of the first candidate effect scenario, the second candidate effect scenario and the third candidate effect scenario being sequentially the second candidate effect scenario, the first candidate effect scenario and the third candidate effect scenario, the second candidate effect scenario may be determined as the target effect scenario.

In the embodiment of the present disclosure, the second file may further be configured to describe an effect keyword and an association relationship between the effect keyword and the selection priority order of the plurality of candidate effect scenarios. Wherein the effect keyword may be a preset keyword used for guiding an effect process operation. Exemplarily, the effect keyword may be a preset keyword configured to describe at least one selected from the group of information: effect outcome, object for effect processing, and effect scenario associated with the image to be processed, etc. Taking a stylized effect as an example, the effect keyword may be oil painting style, comic style, or sketch style, etc. In the embodiment of the present disclosure, the number of effect keywords in the second file may be one, two, or more than two.

In the embodiment of the present disclosure, for one effect keyword, a selection priority order of a plurality of candidate effect scenarios may be set. Following the above example: the effect keyword may include a first keyword, a second keyword and a third keyword. Wherein the selection priority order of the plurality of candidate effect scenarios corresponding to the first keyword may be sequentially: the first candidate effect scenario, the second candidate effect scenario and the third candidate effect scenario; the selection priority order of the plurality of candidate effect scenarios corresponding to the second keyword may be sequentially: the second candidate effect scenario, the first candidate effect scenario and the third candidate effect scenario; the selection priority order of the plurality of candidate effect scenarios corresponding to the third keyword may be sequentially: the third candidate effect scenario, the second candidate effect scenario and the first candidate effect scenario.

It should be noted that the plurality of candidate effect scenarios corresponding to different effect keywords may be either identical or different. In response to the plurality of candidate effect scenarios corresponding to different effect keywords being identical, the selection priority order of the plurality of candidate effect scenarios for each effect keyword may be either identical or different. The selection priority order of the plurality of candidate effect scenarios may be determined by selection priorities of the plurality of candidate effect scenarios.

Based on the above-described embodiments, the determining the target effect scenario corresponding to the image to be processed from among the plurality of candidate effect scenarios according to the second file may include: determining an effect keyword corresponding to the image to be processed, and determining the target effect scenario corresponding to the image to be processed from among the plurality of candidate effect scenarios according to the effect keyword and the second file. By adopting the technical solution, in combination with the effect keyword, the preset effect processing scenario that better matches with the image to be processed may be determined more accurately as the target processing scenario, thereby enhancing the effect processing outcome of the image to be processed.

Specifically, after determining the candidate effect scenarios, the effect keyword corresponding to the image to be processed may be determined. After determining the effect keyword corresponding to the image to be processed, the effect keyword may be matched with the effect keywords in the second file. Further, according to the matched result, the effect keyword in the second file that matches with the effect keyword corresponding to the image to be processed may be determined. Further, the selection priority order of the plurality of candidate effect scenarios associated with the matched effect keyword may be determined, based on an association relationship between the effect keyword and the selection priority order of the plurality of candidate effect scenarios in the second file. Consequently, based on the selection priority order of the plurality of candidate effect scenarios, the target effect scenario corresponding to the image to be processed may be determined from among the plurality of candidate effect scenarios.

In the embodiment of the present disclosure, there are a variety of methods of determining the effect keyword corresponding to the image to be processed, which will not be specifically limited here. As an optional implementation of the embodiment of the present disclosure, image content identification processing may be performed on the image to be processed to obtain an image content identification result. Further, the effect keyword corresponding to the image to be processed may be obtained based on the image content identification result.

As another optional implementation of the embodiment of the present disclosure, in the embodiment of the present disclosure, the effect keyword may be customized through an effect keyword setting interface, with minimal operational complexity; wherein the keyword setting interface may be understood as an interface configured to set the effect keyword corresponding to the image to be processed. Specifically, the effect keyword setting interface may be displayed in response to the effect trigger operation for the target effect; and the effect keyword setting interface receives an effect keyword set operation, to obtain the effect keyword corresponding to the image to be processed.

It should be noted that in the embodiment of the present disclosure, the effect keyword set through the effect keyword setting interface may be either preset before acquiring the image to be processed, or set concurrently while acquiring the image to be processed.

S240: generating an effect processing request according to the target effect scenario; performing a requested effect processing on the image to be processed according to the effect processing request to obtain an effect outcome image; and displaying the effect outcome image.

In the technical solution of the embodiment of the present disclosure, the second file corresponding to the target effect is acquired in response to the number of candidate effect scenarios being a plural. Since the second file is at least configured to describe the selection priority order of the plurality of candidate effect scenarios, the selection priority order of the plurality of candidate effect scenarios may be clearly and intuitively presented through the second file. Moreover, by presenting in the form of static data file, the selection priority order of the plurality of candidate effect scenarios may be conveniently modified, maintained and reused. Further, by determining the target effect scenario corresponding to the image to be processed from among the plurality of candidate effect scenarios according to the second file, the target effect scenario applicable to the image to be processed may be rapidly and conveniently determined through the second file, thereby enhancing the effect processing outcome.

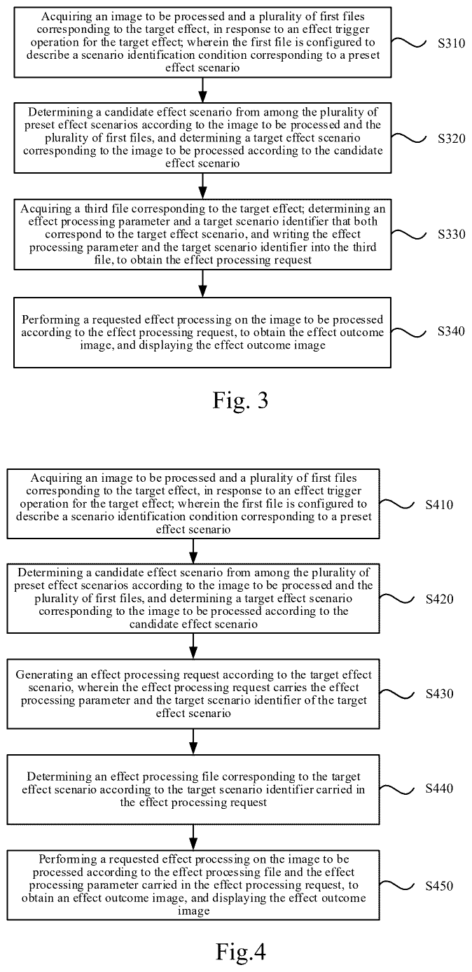

FIG. 3 is a schematic flow chart of yet another effect processing method provided by an embodiment of the present disclosure. Based on the above-described embodiment, the technical solution of this embodiment provides further refinement regarding the method of generating an effect processing request according to the target effect scenario. Optionally, the method of generating an effect processing request according to the target effect scenario includes: acquiring a third file corresponding to the target effect; determining an effect processing parameter and a target scenario identifier (e.g., a first scenario identifier) corresponding to the target effect scenario; and writing the effect processing parameter and the target scenario identifier into the third file, to obtain the effect processing request. For specific implementation, description of this embodiment may be referred to. Technical features that are identical or similar to those in the foregoing embodiments will not be repeated here. As shown in FIG. 3, the method according to this embodiment may specifically include:

S310: acquiring an image to be processed and a plurality of first files corresponding to the target effect, in response to an effect trigger operation for the target effect; wherein the first file is configured to describe a scenario identification condition corresponding to a preset effect scenario.

S320: determining a candidate effect scenario from among the plurality of preset effect scenarios according to the image to be processed and the plurality of first files, and determining a target effect scenario corresponding to the image to be processed according to the candidate effect scenario.

S330: acquiring a third file corresponding to the target effect; determining an effect processing parameter and a target scenario identifier that both correspond to the target effect scenario, and writing the effect processing parameter and the target scenario identifier into the third file, to obtain the effect processing request.

Wherein the third file may be a preset file configured to generate the effect processing request for the target effect. In the embodiment of the present disclosure, a file format of the third file may be JSON format. In the third file, the effect processing request is represented in the form of key-value pairs, which not only makes the effect processing request easy to parse, but also may meet data request requirements of different data types. The effect processing parameter may be understood as a parameter configured to perform effect processing on the image to be processed.

In the embodiment of the present disclosure, the effect processing parameter may include a model-associated parameter of an effect processing model corresponding to the target effect. In addition, the model-associated parameter may further include a parameter for model training (e.g., the number of times of training) and a structural parameter of the model. In the embodiment of the present disclosure, the model-associated parameter may at least include a model input parameter. The model input parameter may include a preset parameter and/or a customized parameter. The model input parameter may at least include model prompt information. Optionally, the effect processing model may be a content generation model. The model prompt information may include effect display outcome information. Optionally, the model prompt information may include positive prompt information and/or negative prompt information. The target scenario identifier may be understood as an identifier of the target effect scenario, which may be configured to determine the target effect scenario.

In the embodiment of the present disclosure, after determining the target effect scenario, the third file corresponding to the target effect scenario may be acquired, and the effect processing parameter and the target scenario identifier that correspond to the target effect scenario may be determined. Further, the effect processing parameter and the target scenario identifier may be written into the third file. After completion of information writing, an effect processing request may be generated based on the third file having information writing completed. Wherein the writing the effect processing parameter and the target scenario identifier into the third file may specifically be: firstly determining a data storage format of the third file; and then writing the effect processing parameter and the target scenario identifier into the third file according to the data storage format.

In the embodiment of the present disclosure, the determining the effect processing parameter corresponding to the target effect scenario may include: determining a target input parameter (e.g., a first input parameter) according to an information input operation in response to the information input operation, and determining the effect processing parameter corresponding to the target effect scenario, according to the target input parameter and a preset processing parameter corresponding to the target effect scenario. Wherein the information input operation may be understood as an operation configured to input a customized effect processing parameter. The target input parameter may be an effect processing parameter obtained based on the information input operation. In the embodiment of the present disclosure, the number of target input parameters may be one, two, or more than two. The preset processing parameter may be understood as a default effect processing parameter preset for the target effect scenario. The number of preset processing parameters may be one, two, or more than two.

In the embodiment of the present disclosure, the determining a target input parameter according to the information input operation may be: obtaining an input parameter after receiving the information input operation. Further, the target input parameter may be obtained based on the input parameter. There are a variety of methods of obtaining the target input parameter based on the input parameter. For example: the input parameter may be determined as the target input parameter. Or, parameter filtering may be performed on the input parameter based on a preset parameter filtering condition, to obtain a filtered parameter. Then the filtered parameter may be determined as the target input parameter; wherein the number of preset parameter filtering conditions may be set according to the claims. In the embodiment of the present disclosure, the purpose of the preset parameter filtering condition is to eliminate an invalid parameter from the input parameters, so as to determine the effect processing parameter more rapidly, to further enhance efficiency of effect processing.

In the embodiment of the present disclosure, there are a variety of methods of determining the effect processing parameter corresponding to the target effect scenario according to the target input parameter and the preset processing parameter corresponding to the target effect scenario. As an optional implementation in the embodiment of the present disclosure: in response to the target input parameter and the preset processing parameter having no identical parameters, the target input parameter and the preset processing parameter corresponding to the target effect scenario may be determined as the effect processing parameters corresponding to the target effect scenario. Or, the target input parameter may be determined as the effect processing parameter corresponding to the target effect scenario. Or, the preset processing parameter corresponding to the target effect scenario may be determined as the effect processing parameter corresponding to the target effect scenario.

As another optional implementation in the embodiment of the present disclosure, in response to the target input parameter and the preset processing parameter having identical parameters, a parameter different between the target input parameter and the preset processing parameter may be added into the preset processing parameter; or a parameter different between the preset processing parameter and the target input parameter may be added into the target input parameter. Such processing may effectively prevent occurrence of duplicate effect processing parameters in the effect processing parameters corresponding to the target effect scenario.

S340: performing a requested effect processing on the image to be processed according to the effect processing request, to obtain the effect outcome image, and displaying the effect outcome image.

In the technical solution of the embodiment of the present disclosure, the third file corresponding to the target effect is acquired, the effect processing parameter and the target scenario identifier that correspond to the target effect scenario are determined, and the effect processing parameter and the target scenario identifier are written into the third file, to obtain the effect processing request, thereby implementing the functionality of obtaining the effect processing request through the third file.

FIG. 4 is a schematic flow chart of still another effect processing method provided by an embodiment of the present disclosure. Based on the above-described embodiment, the technical solution of this embodiment provides further refinement regarding the method of performing the requested effect processing on the image to be processed according to the effect processing request. Optionally, the effect processing request carries the effect processing parameter and the target scenario identifier of the target effect scenario; and the performing the requested effect processing on the image to be processed according to the effect processing request, includes: determining an effect processing file corresponding to the target effect scenario according to the target scenario identifier carried in the effect processing request; wherein the effect processing file is configured to describe the effect process operation to be executed and the effect processing parameter associated with the effect process operation; and performing the requested effect processing on the image to be processed according to the effect processing parameter carried in the effect processing request and the effect processing file. For specific implementation, description of this embodiment may be referred to. Technical features that are identical or similar to those in the foregoing embodiments will not be repeated here. As shown in FIG. 4, the method according to this embodiment may specifically include:
S410: acquiring an image to be processed and a plurality of first files corresponding to the target effect, in response to an effect trigger operation for the target effect; wherein the first file is configured to describe a scenario identification condition corresponding to a preset effect scenario.

S420: determining a candidate effect scenario from among the plurality of preset effect scenarios according to the image to be processed and the plurality of first files, and determining a target effect scenario corresponding to the image to be processed according to the candidate effect scenario.

S430: generating an effect processing request according to the target effect scenario, wherein the effect processing request carries the effect processing parameter and the target scenario identifier of the target effect scenario.

Wherein the target scenario identifier may be configured to determine the target effect scenario. The effect processing parameter may be understood as a parameter configured to perform effect processing on the image to be processed.

S440: determining an effect processing file corresponding to the target effect scenario according to the target scenario identifier carried in the effect processing request.

Wherein the effect processing file may be configured to describe the effect process operation to be executed and the effect processing parameter associated with the effect process operation. The effect processing file may be understood as program execution data for effect processing. In the embodiment of the present disclosure, the program execution data may exist in various forms, including, for example, program data of a visual node and program data in a code form. The visual program data may intuitively present program flow and data streams through graphical interfaces and visual nodes, facilitating development and testing.

Specifically, a correspondence relationship between the scenario identifier and the effect processing file is acquired. Further, the effect processing file corresponding to the target effect scenario may be determined based on the relationship and the target scenario identifier carried in the effect processing request. In the embodiment of the present disclosure, the correspondence relationship between the scenario identifier and the effect processing file may be stored in a preset list, which not only facilitates searching for the effect processing file corresponding to the scenario identifier, but also simplifies management of the correspondence between the scenario identifier and the effect processing file.

S450: performing a requested effect processing on the image to be processed according to the effect processing file and the effect processing parameter carried in the effect processing request, to obtain an effect outcome image, and displaying the effect outcome image.

Wherein the effect outcome image may be understood as a resulted image obtained after performing effect processing on the image to be processed. Specifically, after determining the effect processing file corresponding to the target effect scenario, the effect processing parameter carried in the effect processing request may be assigned as an actual parameter to a formal parameter in the effect processing file that correspond to the effect processing parameter in the effect processing request. Upon completion of parameter assignment, the effect process operation in the effect processing file may be executed, thereby performing effect processing on the image to be processed through execution of the effect process operation. Further, the effect outcome image may be obtained. After obtaining the effect outcome image, the effect outcome image may be displayed.

It should be noted that in the embodiment of the present disclosure, after transmitting the effect processing parameter carried in the effect processing request to the node of the effect processing parameter in the visual effect processing file, secondary editing may be performed on the effect processing parameter included in the node; the secondary editing includes, for example, at least one selected from the group of effect processing parameter editing: modifying an effect processing parameter, adding an effect processing parameter, or deleting an effect processing parameter.

As an optional implementation of the embodiment of the present disclosure, the first file, the second file and the third file may serve as protocol files of the target effect. The protocol file may be configured to set data associated with application logic of the target effect, so that an application terminal may smoothly utilize the target effect according to the application logic of the target effect. To ensure that the target effect is used smoothly on the application terminal, the data format contained in the protocol file may also be set according to a runtime environment of the application terminal.

In the technical solution of the embodiment of the present disclosure, the effect processing file corresponding to the target effect scenario is determined according to the target scenario identifier carried in the effect processing request; wherein the effect processing file is configured to describe the effect process operation to be executed and the effect processing parameter associated with the effect process operation; and the effect processing is performed on the image to be processed according to the effect processing parameter carried in the effect processing request and the effect processing file, which further refines effect processing for the image to be processed.

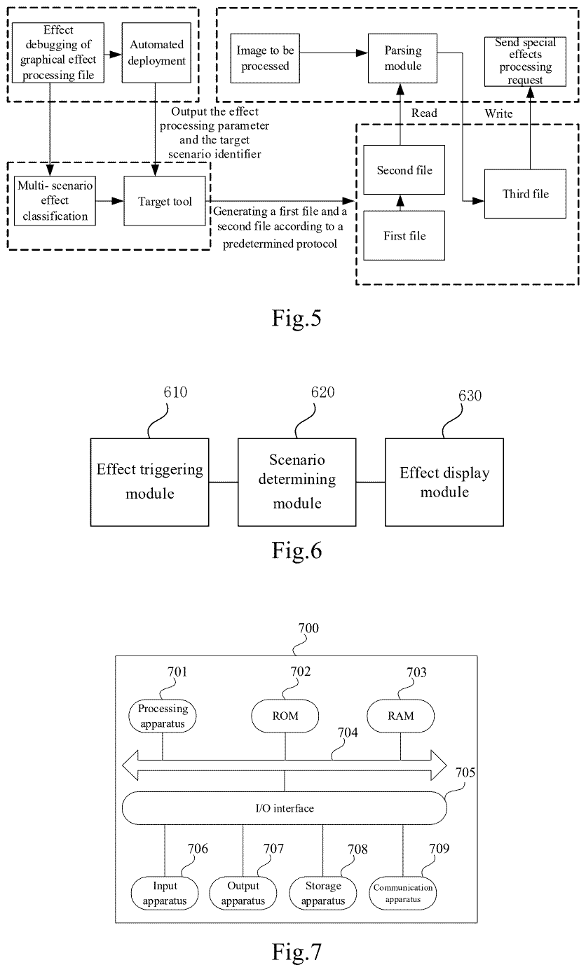

As an optional implementation of the embodiment of the present disclosure, and with reference to FIG. 5, specific steps of the effect processing method according to this embodiment may include:

Step One: an effect processing file corresponding to a plurality of preset effect scenarios is pre-created by using a graphical programming tool, and effect debugging is performed on the effect processing file under each preset effect scenario, to obtain the effect processing file with an effect outcome that meets expectation. Additionally, a target tool is adopted to create a first file corresponding to each preset effect scenario, a second file configured to determine a selection priority order of the plurality of preset effect scenarios, and a third file configured to generate an effect processing request. Wherein the first file is configured to describe a scenario identification condition corresponding to a preset effect scenario. The second file is configured to describe the selection priority order of the plurality of preset effect scenarios.

Step Two: after receiving an effect trigger operation for a target effect, an image to be processed may be acquired; through a parsing module, a preset effect scenario corresponding to the image to be processed, namely, a candidate effect scenario, is determined by parsing the scenario identification condition in the plurality of first files corresponding to the target effect.

Step Three: in response to the number of candidate effect scenarios being a plural, an effect keyword corresponding to the image to be processed may be determined. Then, the effect keyword is matched with the effect keyword in the second file, and further a target effect scenario corresponding to the image to be processed may be determined from among the plurality of candidate effect scenarios based on the matched result. In response to there being no matched effect keyword, a selection priority order of the plurality of candidate effect scenarios corresponding to a default keyword may be adopted.

Step Four: in response to having determined the target effect scenario, a target effect scenario identifier and an effect processing parameter that both correspond to the target effect scenario may be obtained. Further, the target effect scenario identifier and the effect processing parameter may be written into the third file, to obtain an effect processing request for the image to be processed.

Step Five: an effect processing file corresponding to the target effect scenario may be determined according to the target scenario identifier carried in the effect processing request. Further, the effect processing parameter may be taken as an actual parameter and transmitted to a formal parameter of the effect process operation in the effect processing file that corresponds to the effect processing parameter. Upon completion of parameter transmission, effect processing may be performed on the image to be processed by executing the effect process operation, to obtain an effect outcome image, and the effect outcome image is displayed. In the embodiment of the present disclosure, the effect processing request may be generated on a client and then transmitted to a server where the effect processing is executed.

The technical solution of the embodiment of the present disclosure solves the technical problems of high coupling in effect processing logic codes and poor reusability existing in effect processing of the related technologies, and implements constructing a plurality of effect scenarios through the first file and the second file and orderly combining the plurality of effect scenarios, so that complex effect processing logic codes in the related technologies may be converted into manageable data structures, thereby decoupling complex effect processing logic codes while facilitating effect scenario expansion and modification. As compared with the method of compiling dedicated effect processing logic codes for each effect scenario, the solution saves required memory space and allows convenient reuse. On this basis, the solution further standardizes the data format of effect processing requests through the third file, making the effect processing requests easy for parsing.

FIG. 6 is a structural schematic diagram of an effect processing apparatus provided by an embodiment of the present disclosure; as shown in FIG. 6, the apparatus includes: an effect triggering module 610, a scenario determining module 620 and an effect display module 630. The effect triggering module 610 is configured to acquire an image to be processed and a plurality of first files corresponding to the target effect, in response to an effect trigger operation for the target effect, wherein the first file is configured to describe a scenario identification condition corresponding to a preset effect scenario; the scenario determining module 620 is configured to determine a candidate effect scenario from among the plurality of preset effect scenarios according to the image to be processed and the plurality of first files, and determine a target effect scenario corresponding to the image to be processed according to the candidate effect scenario; and the effect display module 630 is configured to generate an effect processing request according to the target effect scenario, perform effect processing on the image to be processed according to the effect processing request to obtain an effect outcome image, and display the effect outcome image.

In the technical solution of the embodiment of the present disclosure, the effect triggering module 610 acquires the image to be processed and the plurality of first files corresponding to the target effect, in response to the effect trigger operation for the target effect. Since the first file is configured to describe the scenario identification condition corresponding to the preset effect scenario, division of for multi-effect scenario with respect to the target effect may be implemented through the plurality of first files corresponding to a plurality of preset effect scenarios, which supports effect processing for divided effect scenarios with respect to the same effect. Moreover, by presenting the scenario identification condition corresponding to the preset effect scenario in the form of static data file, the scenario identification condition corresponding to the plurality of preset effect scenarios may be conveniently modified, maintained and reused. Thereafter, the scenario determining module 620 determines the candidate effect scenario from among the plurality of preset effect scenarios according to the image to be processed and the plurality of first files, and then determines the target effect scenario corresponding to the image to be processed according to the candidate effect scenario, the effect processing scenario applicable to the image to be processed may be identified more rapidly according to the plurality of first files, thereby implementing targeted processing of the image to be processed. Further, the effect display module 630 generates the effect processing request according to the target effect scenario, performs effect processing on the image to be processed according to the effect processing request to obtain the effect outcome image, and displays the effect outcome image, the effect processing scenario applicable to the image to be processed may be adopted to perform effect processing on the image to be processed, so that different images to be processed may exhibit effects that closely match with the images to be processed. The technical solution of the embodiment of the present disclosure solves the technical problem in the related technologies that the effect outcome of the image fails to meet expectations since the effect process operation and the effect processing parameter in the effect processing file are relatively fixed, implements decoupling the effect processing logic code through the first file, and achieves the technical effect of reusing the effect processing logic.

In any optional technical solution of the embodiment of the present disclosure, optionally, the scenario determining module 620 includes a candidate scenario determining unit. The candidate scenario determining unit is configured to determine the preset effect scenario corresponding to the first file as the candidate effect scenario in response to the image to be processed satisfying the scenario identification condition included in the first file.

In any optional technical solution of the embodiment of the present disclosure, optionally, the apparatus further includes a condition editing module. Further, the condition editing module is configured to receive a condition edit operation for at least one scenario identification condition in the first file, before or after acquiring the plurality of first files corresponding to the target effect, and update the first file according to the condition edit operation.

In any optional technical solution of the embodiment of the present disclosure, optionally, the scenario determining module 620 includes a target scenario determining unit. Wherein the target scenario determining unit is configured to acquire a second file corresponding to the target effect, in response to the number of candidate effect scenarios being a plural, and determine the target effect scenario corresponding to the image to be processed from among the plurality of candidate effect scenarios according to the second file; wherein the second file is at least configured to describe a selection priority order of the plurality of candidate effect scenarios.

In any optional technical solution of the embodiment of the present disclosure, optionally, the second file is further configured to describe an effect keyword and an association relationship between the effect keyword and the selection priority order of the plurality of candidate effect scenarios; further, the target scenario determining unit is specifically configured to determine an effect keyword corresponding to the image to be processed, and determine the target effect scenario corresponding to the image to be processed from among the plurality of candidate effect scenarios according to the effect keyword and the second file.

In any optional technical solution of the embodiment of the present disclosure, optionally, the effect display module 630 includes an effect request generating unit. The effect request generating unit is configured to acquire a third file corresponding to the target effect; determine an effect processing parameter and a target scenario identifier that both correspond to the target effect scenario; and write the effect processing parameter and the target scenario identifier into the third file, to obtain the effect processing request.

In any optional technical solution of the embodiment of the present disclosure, optionally, the effect request generating unit is configured to determine a target input parameter according to an information input operation in response to the information input operation, and determine the effect processing parameter corresponding to the target effect scenario according to the target input parameter and a preset processing parameter corresponding to the target effect scenario.

In any optional technical solution of the embodiment of the present disclosure, optionally, the effect processing parameter includes a model-associated parameter of the effect processing model corresponding to the target effect; the model-associated parameter at least includes a model input parameter; and the model input parameter at least includes model prompt information.

In any optional technical solution of the embodiment of the present disclosure, optionally, the effect processing request carries the effect processing parameter and the target scenario identifier of the target effect scenario; further, the effect display module 630 includes an effect processing unit. The effect processing unit is configured to determine an effect processing file corresponding to the target effect scenario according to the target scenario identifier carried in the effect processing request; wherein the effect processing file is configured to describe the effect process operation to be executed and the effect processing parameter associated with the effect process operation; and perform effect processing on the image to be processed according to the effect processing parameter carried in the effect processing request and the effect processing file.

The effect processing apparatus provided by the embodiment of the present disclosure may execute the effect processing method provided by any embodiment of the present disclosure, and has corresponding functional modules and advantageous effects for executing the effect processing method.

It is worth noting that the respective units and modules included in the above-described apparatus are only divided according to functional logic, but are not limited to the above-described division, as long as the corresponding functions may be implemented; in addition, specific names of the respective functional units are only intended to facilitate distinguishing them from each other, and are not used to limit the scope of protection of the embodiments of the present disclosure.

Referring next to FIG. 7, it shows a structural schematic diagram of an electronic device (e.g., a terminal device or a server) 700 suitable for implementing an embodiment of the present disclosure. The terminal device according to the embodiment of the present disclosure may include, but is not limited to, a mobile terminal such as a mobile phone, a laptop, a digital broadcast receiver, a personal digital assistant (PDA), a portable android device (PAD), a portable multimedia player (PMP), a vehicle-mounted terminal (e.g., a vehicle-mounted navigation terminal), etc., and a stationary terminal such as a digital TV, a desktop computer, etc. The electronic device shown in FIG. 7 is only an example, and should not impose any limitation on the function and use scope of the embodiments of the present disclosure.

As shown in FIG. 7, the electronic device 700 may include a processing apparatus (e.g., a central processing unit, a graphics processor, etc.) 701, which may execute various appropriate actions and processing according to a program stored in a read-only memory (ROM) 702 or a program loaded from a storage apparatus 708 into a random access memory (RAM) 703. The RAM 703 further stores various programs and data required for operation of the electronic device 700. The processing apparatus 701, the ROM 702, and the RAM 703 are connected with each other through a bus 704. An input/output (I/O) interface 705 is also coupled to the bus 704.

Usually, apparatuses below may be coupled to the I/O interface 705: input apparatuses 707 including, for example, a touch screen, a touch pad, a keyboard, a mouse, a camera, a microphone, an accelerometer, a gyroscope, etc.; output apparatuses 707 including, for example, a liquid crystal display (LCD), a speaker, a vibrator, etc.; a storage apparatus 708 including, for example, a magnetic tape, a hard disk, etc.; and a communication apparatus 709. The communication apparatus 709 may allow the electronic device 700 to perform wireless or wired communication with other device so as to exchange data. Although FIG. 7 shows the electronic device 700 having various apparatuses, it should be understood that, it is not required to implement or have all the apparatuses shown, and the electronic device 700 may alternatively implement or have more or fewer apparatuses.

Particularly, according to the embodiments of the present disclosure, the flows as described above with reference to the flow charts may be implemented as computer software programs. For example, the embodiments of the present disclosure include a computer program product, including a computer program carried on a non-transitory computer-readable medium, the computer program containing program codes for executing the method illustrated in the flow chart. In such embodiments, the computer program may be downloaded and installed from the network via the communication apparatus 709, or installed from the storage apparatus 708, or installed from the ROM 702. When executed by the processing apparatus 701, the computer program executes the above-described functions limited in the methods according to the embodiments of the present disclosure.

Names of messages or information interacted between a plurality of apparatuses according to the implementations of the present disclosure are only used for illustrative purposes, and are not used to limit the scope of these messages or information.

The electronic device provided by the embodiment of the present disclosure belongs to a same inventive concept as the effect processing method provided by the above-described embodiments. The above-described embodiments may be referred to for technical details not described in detail in this embodiment; and this embodiment has the same effects as the above-described embodiments.

An embodiment of the present disclosure provides a computer storage medium, having a computer program stored thereon; wherein the program, when executed by a processor, implements the effect processing method provided by the above-described embodiment.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

According to one or more embodiments of the present disclosure, example one provides an effect processing method, which includes:
acquiring an image to be processed and a plurality of first files corresponding to a target effect, in response to an effect trigger operation for the target effect, wherein a first file of the plurality of first files is configured to describe a scenario identification condition corresponding to a preset effect scenario;
determining a candidate effect scenario from among a plurality of preset effect scenarios according to the image to be processed and the plurality of first files, and determining a target effect scenario corresponding to the image to be processed according to the candidate effect scenario; and generating an effect processing request according to the target effect scenario, performing the requested effect processing on the image to be processed according to the effect processing request to obtain an effect outcome image, and displaying the effect outcome image.

According to one or more embodiments of the present disclosure, example two provides the method in example one, which further includes: optionally,
the determining a candidate effect scenario from among a plurality of preset effect scenarios according to the image to be processed and the plurality of first files, includes: determining the preset effect scenario corresponding to the first file as the candidate effect scenario in response to the image to be processed satisfying the scenario identification condition in the first file.

According to one or more embodiments of the present disclosure, example three provides the method in example one, which further includes: optionally,
wherein before or after the acquiring a plurality of first files corresponding to a target effect, the method further includes: receiving a condition edit operation for at least one scenario identification condition in the first file, and updating the first file according to the condition edit operation.

According to one or more embodiments of the present disclosure, example four provides the method in example one, which further includes: optionally,
the determining a target effect scenario corresponding to the image to be processed according to the candidate effect scenario, includes: acquiring a second file corresponding to the target effect, in response to the candidate effect scenario being a plurality of candidate effect scenarios, and determining the target effect scenario corresponding to the image to be processed from among the plurality of candidate effect scenarios according to the second file, wherein the second file is at least configured to describe a selection priority order of the plurality of candidate effect scenarios.

According to one or more embodiments of the present disclosure, example five provides the method in example one, which further includes: optionally,
the second file is further configured to describe an effect keyword and an association relationship between the effect keyword and the selection priority order of the plurality of candidate effect scenarios; the determining a target effect scenario corresponding to the image to be processed from among the plurality of candidate effect scenarios according to the second file, includes: determining an effect keyword corresponding to the image to be processed, and determining the target effect scenario corresponding to the image to be processed from among the plurality of candidate effect scenarios according to the effect keyword and the second file.

According to one or more embodiments of the present disclosure, example six provides the method in example one, which further includes: optionally,
the generating an effect processing request according to the target effect scenario, includes: acquiring a third file corresponding to the target effect, determining an effect processing parameter and a target scenario identifier both corresponding to the target effect scenario, and writing the effect processing parameter and the target scenario identifier into the third file, to obtain the effect processing request.

According to one or more embodiments of the present disclosure, example seven provides the method in example one, which further includes: optionally,
the determining an effect processing parameter corresponding to the target effect scenario, includes:
determining a target input parameter according to an information input operation in response to the information input operation, and determining the effect processing parameter corresponding to the target effect scenario according to the target input parameter and a preset processing parameter corresponding to the target effect scenario.

According to one or more embodiments of the present disclosure, example eight provides the method in example one, which further includes: optionally,
the effect processing parameter includes a model-associated parameter of an effect processing model corresponding to the target effect, the model-associated parameter at least includes a model input parameter, and the model input parameter at least includes model prompt information.

According to one or more embodiments of the present disclosure, example nine provides the method in example one, which further includes: optionally,
the effect processing request carries the effect processing parameter and the target scenario identifier of the target effect scenario; the performing the requested effect processing on the image to be processed according to the effect processing request, includes: determining an effect processing file corresponding to the target effect scenario according to the target scenario identifier carried in the effect processing request, wherein the effect processing file is configured to describe an effect process operation to be executed and the effect processing parameter associated with the effect process operation; and performing the requested effect processing on the image to be processed according to the effect processing parameter carried in the effect processing request and the effect processing file.

According to one or more embodiments of the present disclosure, example ten provides an effect processing apparatus. The apparatus includes:
an effect triggering module, configured to acquire an image to be processed and a plurality of first files corresponding to the target effect, in response to an effect trigger operation for the target effect, wherein a first file of the plurality of first files is configured to describe a scenario identification condition corresponding to a preset effect scenario; a scenario determining module, configured to determine a candidate effect scenario from among a plurality of preset effect scenarios according to the image to be processed and the plurality of first files, and determine a target effect scenario corresponding to the image to be processed according to the candidate effect scenario; and an effect display module, configured to generate an effect processing request according to the target effect scenario, perform effect processing on the image to be processed according to the effect processing request to obtain an effect outcome image, and display the effect outcome image.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: acquire an image to be processed and a plurality of first files corresponding to a target effect, in response to an effect trigger operation for the target effect, wherein a first file of the plurality of first files is configured to describe a scenario identification condition corresponding to a preset effect scenario; determine a candidate effect scenario from among a plurality of preset effect scenarios according to the image to be processed and the plurality of first files, and determine a target effect scenario corresponding to the image to be processed according to the candidate effect scenario; and generate an effect processing request according to the target effect scenario, perform effect processing on the image to be processed according to the effect processing request to obtain an effect outcome image, and display the effect outcome image.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances, for example, the effect display module may also be described as “a module for displaying effect images”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An effect processing method, comprising:
acquiring a first image and a plurality of first files corresponding to a first effect, in response to an effect trigger operation for the first effect, wherein a first file of the plurality of first files is configured to describe a scenario identification condition corresponding to a preset effect scenario;
determining a candidate effect scenario from among a plurality of preset effect scenarios according to the first image and the plurality of first files, and determining a first effect scenario corresponding to the first image according to the candidate effect scenario; and
generating an effect processing request according to the first effect scenario, performing a requested effect processing on the first image according to the effect processing request to obtain an effect outcome image, and displaying the effect outcome image.

2. The effect processing method according to claim 1, wherein the determining a candidate effect scenario from among a plurality of preset effect scenarios according to the first image and the plurality of first files, comprises:
determining the preset effect scenario corresponding to the first file as the candidate effect scenario in response to the first image satisfying the scenario identification condition in the first file.

3. The effect processing method according to claim 1, wherein before or after the acquiring a plurality of first files corresponding to a first effect, the method further comprises:
receiving a condition edit operation for at least one scenario identification condition in the first file, and updating the first file according to the condition edit operation.

4. The effect processing method according to claim 1, wherein the determining a first effect scenario corresponding to the first image according to the candidate effect scenario, comprises:
acquiring a second file corresponding to the first effect, in response to the candidate effect scenario being a plurality of candidate effect scenarios, and determining the first effect scenario corresponding to the first image from among the plurality of candidate effect scenarios according to the second file, wherein the second file is at least configured to describe a selection priority order of the plurality of candidate effect scenarios.

5. The effect processing method according to claim 4, wherein the second file is further configured to describe an effect keyword and an association relationship between the effect keyword and the selection priority order of the plurality of candidate effect scenarios;
the determining a first effect scenario corresponding to the first image from among the plurality of candidate effect scenarios according to the second file, comprises:
determining an effect keyword corresponding to the first image, and determining the first effect scenario corresponding to the first image from among the plurality of candidate effect scenarios according to the effect keyword and the second file.

6. The effect processing method according to claim 1, wherein the generating an effect processing request according to the first effect scenario, comprises:
acquiring a third file corresponding to the first effect, determining an effect processing parameter and a first scenario identifier both corresponding to the first effect scenario, and writing the effect processing parameter and the first scenario identifier into the third file, to obtain the effect processing request.

7. The effect processing method according to claim 6, wherein the determining an effect processing parameter corresponding to the first effect scenario, comprises:
determining a first input parameter according to an information input operation in response to the information input operation, and determining the effect processing parameter corresponding to the first effect scenario according to the first input parameter and a preset processing parameter corresponding to the first effect scenario.

8. The effect processing method according to claim 6, wherein the effect processing parameter comprises a model-associated parameter of an effect processing model corresponding to the first effect, the model-associated parameter at least comprises a model input parameter, and the model input parameter at least comprises model prompt information.

9. The effect processing method according to claim 6, wherein the effect processing request carries the effect processing parameter and the first scenario identifier of the first effect scenario;
the performing a requested effect processing on the first image according to the effect processing request, comprises:
determining an effect processing file corresponding to the first effect scenario according to the first scenario identifier carried in the effect processing request, wherein the effect processing file is configured to describe an effect process operation to be executed and the effect processing parameter associated with the effect process operation; and
performing the requested effect processing on the first image according to the effect processing parameter carried in the effect processing request and the effect processing file.

10. An electronic device, comprising:
at least one processor;
a storage apparatus, configured to store at least one program;
wherein the at least one program, when executed by the at least one processor, cause the at least one processor to implement an effect processing method, which comprises:
acquiring a first image and a plurality of first files corresponding to a first effect, in response to an effect trigger operation for the first effect, wherein a first file of the plurality of first files is configured to describe a scenario identification condition corresponding to a preset effect scenario;
determining a candidate effect scenario from among a plurality of preset effect scenarios according to the first image and the plurality of first files, and determining a first effect scenario corresponding to the first image according to the candidate effect scenario; and
generating an effect processing request according to the first effect scenario, performing a requested effect processing on the first image according to the effect processing request to obtain an effect outcome image, and displaying the effect outcome image.

11. The electronic device according to claim 10, wherein the determining a candidate effect scenario from among a plurality of preset effect scenarios according to the first image and the plurality of first files, comprises:
determining the preset effect scenario corresponding to the first file as the candidate effect scenario in response to the first image satisfying the scenario identification condition in the first file.

12. The electronic device according to claim 10, wherein before or after the acquiring a plurality of first files corresponding to a first effect, the method further comprises:
receiving a condition edit operation for at least one scenario identification condition in the first file, and updating the first file according to the condition edit operation.

13. The electronic device according to claim 10, wherein the determining a first effect scenario corresponding to the first image according to the candidate effect scenario, comprises:
acquiring a second file corresponding to the first effect, in response to the candidate effect scenario being a plurality of candidate effect scenarios, and determining the first effect scenario corresponding to the first image from among the plurality of candidate effect scenarios according to the second file, wherein the second file is at least configured to describe a selection priority order of the plurality of candidate effect scenarios.

14. The electronic device according to claim 13, wherein the second file is further configured to describe an effect keyword and an association relationship between the effect keyword and the selection priority order of the plurality of candidate effect scenarios;
the determining a first effect scenario corresponding to the first image from among the plurality of candidate effect scenarios according to the second file, comprises:
determining an effect keyword corresponding to the first image, and determining the first effect scenario corresponding to the first image from among the plurality of candidate effect scenarios according to the effect keyword and the second file.

15. The electronic device according to claim 10, wherein the generating an effect processing request according to the first effect scenario, comprises:
acquiring a third file corresponding to the first effect, determining an effect processing parameter and a first scenario identifier both corresponding to the first effect scenario, and writing the effect processing parameter and the first scenario identifier into the third file, to obtain the effect processing request.

16. The electronic device according to claim 15, wherein the determining an effect processing parameter corresponding to the first effect scenario, comprises:
determining a first input parameter according to an information input operation in response to the information input operation, and determining the effect processing parameter corresponding to the first effect scenario according to the first input parameter and a preset processing parameter corresponding to the first effect scenario.

17. The electronic device according to claim 15, wherein the effect processing parameter comprises a model-associated parameter of an effect processing model corresponding to the first effect, the model-associated parameter at least comprises a model input parameter, and the model input parameter at least comprises model prompt information.

18. The electronic device according to claim 15, wherein the effect processing request carries the effect processing parameter and the first scenario identifier of the first effect scenario;
the performing a requested effect processing on the first image according to the effect processing request, comprises:
determining an effect processing file corresponding to the first effect scenario according to the first scenario identifier carried in the effect processing request, wherein the effect processing file is configured to describe an effect process operation to be executed and the effect processing parameter associated with the effect process operation; and
performing the requested effect processing on the first image according to the effect processing parameter carried in the effect processing request and the effect processing file.

19. A non-transitory computer-readable storage medium, comprising computer-executable instructions, wherein the computer-executable instructions, when executed by a computer processor, perform an effect processing method, which comprises:
acquiring a first image and a plurality of first files corresponding to a first effect, in response to an effect trigger operation for the first effect, wherein a first file of the plurality of first files is configured to describe a scenario identification condition corresponding to a preset effect scenario;
determining a candidate effect scenario from among a plurality of preset effect scenarios according to the first image and the plurality of first files, and determining a first effect scenario corresponding to the first image according to the candidate effect scenario; and
generating an effect processing request according to the first effect scenario, performing a requested effect processing on the first image according to the effect processing request to obtain an effect outcome image, and displaying the effect outcome image.

20. The storage medium according to claim 19, wherein the determining a candidate effect scenario from among a plurality of preset effect scenarios according to the first image and the plurality of first files, comprises:
determining the preset effect scenario corresponding to the first file as the candidate effect scenario in response to the first image satisfying the scenario identification condition in the first file.
